(19) United States
(12) Patent Application Publication
(10) Pub. No.: US 2013/0170189 A1
(43) Pub. Date: Jul. 4, 2013

(54) HAND-LAMP DEVICE

(71) Applicants: Tom Staeubli, Zurich (CH); Uwe Werner, Hitter (CH); Arno Lenzi, Zurich (CH); Georgios Margaritis, Schwieberdingen (DE)

(72) Inventors: Tom Staeubli, Zurich (CH); Uwe Werner, Hitter (CH); Arno Lenzi, Zurich (CH); Georgios Margaritis, Schwieberdingen (DE)

(21) Appl. No.: 13/808,666

(22) PCT Filed: Jun. 27, 2011
(86) PCT No.: PCT/EP2011/060682

§ 371 Date: Mar. 25, 2013

(30) Foreign Application Priority Data
Jul. 9, 2010 (DE) 10 2010 031 162.6

(51) Int. Cl. F21V 21/14

(52) U.S. Cl. CPC F21V 21/14
USPC 362/109

(57) ABSTRACT

A hand-lamp device having a battery-receiving area, a swiveling mechanism, a lighting device and a coupling device which is provided to contact a hand-held machine-tool battery located in the battery-receiving area, and which in at least one operating state, is situated between the lighting device and the battery-receiving area. The swiveling mechanism is situated at least partially in an immediate area of the coupling device.

### FIELD

The present invention relates to a hand-lamp device.

### BACKGROUND INFORMATION

U.S. Published Patent Application No. 2006/0113958 describes a hand-lamp device having a battery-receiving area, a swiveling mechanism, a lighting device and a coupling device that is provided to contact a hand-held machine-tool battery located in the battery-receiving area and, in at least one operating state, is situated between the lighting device and the battery-receiving area.

### SUMMARY

The present invention relates to a hand-lamp device having a battery-receiving area, a swiveling mechanism, a lighting device and a coupling device which is provided to contact a hand-held machine-tool battery located in the battery-receiving area, and in at least one operating state, is situated between the lighting device and the battery-receiving area.

The swiveling mechanism is disposed at least partially in an immediate area of the coupling device. A “battery-receiving area” is to be understood in particular as a space that is adjacent to the coupling device and in which, at least in a ready-to-operate state, the hand-held machine-tool battery is situated in a manner that it is contacted by the coupling device. In particular, the term “swiveling mechanism” is to be understood as a mechanism that supports at least the lighting device in a manner allowing it to move, especially relative to the coupling device, about a swivel axis. Preferably, the swiveling mechanism supports the lighting device in a manner allowing it to move by at least 90 degrees, advantageously by at least 145 degrees, about the swivel axis. A “lighting device” is to be understood especially as a device which, during operation, converts an electric power into a luminous flux for the illumination, in particular, of a working place. Preferably, the luminous flux has a power of at least 50 lumens, advantageously, at least 150 lumens. In particular, a “coupling device” is to be understood as a device which is provided to electrically contact and/or especially to mechanically secure a hand-held machine-tool battery. The term “provided” in particular is to be understood as specially designed and/or furnished. A “hand-held machine-tool battery” is to be understood especially as a storage battery provided to supply a hand-held machine tool with electrical energy. In particular, the hand-held machine-tool battery is specially protected against dust and dirt and/or is adapted to an output of the hand-held machine tool. Preferably, the hand-held machine-tool battery has a plurality of cells and/or a voltage greater than 3.6 volts, advantageously greater than 10 volts. The hand-held machine-tool battery especially advantageously has lithium cells. In particular, the hand-held machine-tool battery is provided to output a wattage greater than 25 watts, advantageously greater than 50 watts, particularly advantageously, greater than 100 watts. In particular, the hand-held machine-tool battery is provided to supply a drive motor of a hand-held machine tool with electric power. By “situated between the lighting device and the battery-receiving area” in this connection is to be understood in particular that a plane intersecting the coupling device is situated between two planes parallel to it, the one plane intersecting the battery-receiving area and running next to the lighting device, and the other plane intersecting the lighting device and running next to the battery-receiving area. Preferably, the plane intersecting the coupling means is the coupler plane of the coupling device. Particularly preferred, a vertical of the coupler plane of the coupling device intersects the battery-receiving area, the coupling device and the lighting device, especially in at least this order. At least in a ready-to-operate state, the coupling means is situated preferably between the lighting device and the battery-receiving area. In particular, a “ready-to-operate state” is to be understood as a state, especially a swivel state of the swiveling mechanism, in which a luminous flux of the lighting device is able to be concentrated at least partially, preferably for the most part, on a working surface. An “immediate area of the coupling device” is to be understood especially as an area which is set apart less that 30%, advantageously less than 10%, particularly advantageously, less than 5% of a maximum extension of the hand-lamp device, from at least one part of the coupling means. Advantageously, the immediate area is set apart less than 6 cm, advantageously less than 3 cm, especially advantageously, less than 1.5 cm from at least one part of the coupling device. Preferably, a swivel axis of the swiveling mechanism intersects the immediate area of the coupling device. In particular, all bearing surfaces of the swiveling mechanism are preferably located in the immediate area. The embodiment according to the present invention makes it possible to provide a flexible and especially compact hand-lamp device. In particular, hand-held machine-tool batteries and a charging infrastructure of the hand-held machine-tool battery are able to be used in an especially versatile and efficient manner.

In a further development, the swiveling mechanism has at least one swivel axis which is located in a coupling direction of the coupling device behind the coupling device, thereby permitting an especially compact type of construction with simplicity of design. A “coupling direction” is to be understood particularly as a direction of a movement of the hand-held machine-tool battery in relation to the coupling device, in which the coupling means contacts the hand-held machine-tool battery uncontacted beforehand. “In the coupling direction behind the coupling device” is to be understood in particular that first the coupling device and then the swivel axis are located along the coupling direction. Preferably, the swivel axis is situated in the immediate area of a coupler plane of the coupling device.

Moreover, it is proposed that the swivel axis of the swiveling mechanism be aligned generally in a direction perpendicular to the coupling direction of the coupling device, thereby permitting an advantageous adjustment possibility, accompanied by simplicity of design. In particular, the hand-lamp device may be set down on a resting surface, the hand-held machine-tool battery and/or the hand grip, and the lighting device may be concentrated on a working place. “Generally” is to be understood, in particular, as with a deviation of not more than 30 degrees, advantageously, not more than 10 degrees.

It is further proposed that the swivel axis of the swiveling mechanism be aligned essentially parallel to a coupler plane of the coupling device, which means advantageously, great flexibility and, in particular, small space requirement for a transport may be achieved. A “coupler plane” is to be understood particularly as a plane located on an average main extension of the coupling device.

In addition, the swiveling mechanism is provided to support the lighting device in a manner allowing it to move, especially relative to the coupling device, about at least two swivel axes, thereby permitting an especially flexible alignment of the lighting device even at places difficult to access, and especially at places without horizontal resting surfaces. Preferably, the swiveling mechanism has a bearing ball, especially preferred, a gooseneck. Alternatively, the swiveling mechanism could have two swivel bearings, each having a swivel axis.

Moreover, the coupling device is intended to contact the hand-held-machine-tool battery, situated in the battery-receiving area, in a manner that the contact is disengageable without using a tool, thereby permitting a particularly operator-friendly utilization. Under the term “disengageable without using a tool” is to be understood in particular that the coupling means secures the hand-held machine-tool battery in a manner disengageable by the operator using only his hands.

In addition, the present invention relates to a system having a hand-held machine-tool battery and having a hand-lamp device, especially according to the present invention.

In accordance with the present invention, the example system includes at least one gripping surface that at least partially surrounds at least a part of the hand-held machine-tool battery, especially on a plane which is aligned perpendicularly to the coupling direction. The term “gripping surface” is to be understood especially as a surface which is designed and positioned so that, in a ready-to-operate state, an operator may safely grasp it. Advantageously, the gripping surface includes two points at which a surface alignment has an angle of more than 120 degrees relative to each other, and which are set apart less than 12 cm along a surface. Preferably, the gripping surface is slip-resistant. The term “surround” is intended to mean, in particular, that the gripping surface encircles one point of the hand-held machine-tool battery on one plane by more than 120 degrees, advantageously by more than 270 degrees. Preferably, the system has at least one supporting surface which stabilizes the system when setting the system down on a surface. It is especially preferred that the supporting surface is aligned parallel to the swivel axis. Alternatively or additionally, the system has a markedly non-circular exterior shape.

This embodiment according to the present invention makes it possible to provide a flexible and especially compact system. In particular, hand-held machine-tool batteries and a charging infrastructure of the hand-held machine-tool batteries are able to be used especially efficiently and with versatility.

In a further development, at least a part of the gripping surface is located on a surface of the hand-held machine-tool battery, thereby permitting a particularly compact form of the system. Alternatively or advantageously in addition, a part of the gripping surface could be located on a surface of the hand-lamp device.

In accordance with an example embodiment of the present invention, at least a part of the gripping surface is located on a surface of the hand-lamp device which is smaller than the part of the gripping surface located on the surface of the hand-held machine-tool battery, making it possible to conveniently retain an especially compact hand-lamp device.

In addition, the example system may include a protection device which is provided to protect the coupling device, thereby permitting an advantageously broad spectrum of practical applications. A “protection device” is to be understood in particular as a device which hinders and/or advantageously prevents at least dirt and/or water from penetrating between the coupling device and the hand-held machine-tool battery. Preferably, the protection device provides protection against explosion, particularly according to the EC Directive 94/9/EC.

### BRIEF DESCRIPTION OF THE DRAWINGS

Further advantages are derived from the description below. The figures show four exemplary embodiments of the present invention. The figures and the specification contain numerous features in combination. The features may be considered individually, as well, and may be combined to form further useful combinations.

FIG. 1 shows an example system according to the present invention having a hand-held machine tool and an integratable hand-held machine-tool battery, shown removed.

FIG. 2 shows the system from FIG. 1 having a swiveled swiveling mechanism.

FIG. 3 shows a further exemplary embodiment of the system from FIG. 1 having an externally plugged-in hand-held machine-tool battery.

FIG. 4 shows a further exemplary embodiment of the system from FIG. 1 having a foldable lighting device.

FIG. 5 shows another exemplary embodiment of the system from FIG. 1 having a lighting device able to swivel about several swivel axes.

### DETAILED DESCRIPTION OF EXAMPLE EMBODIMENTS

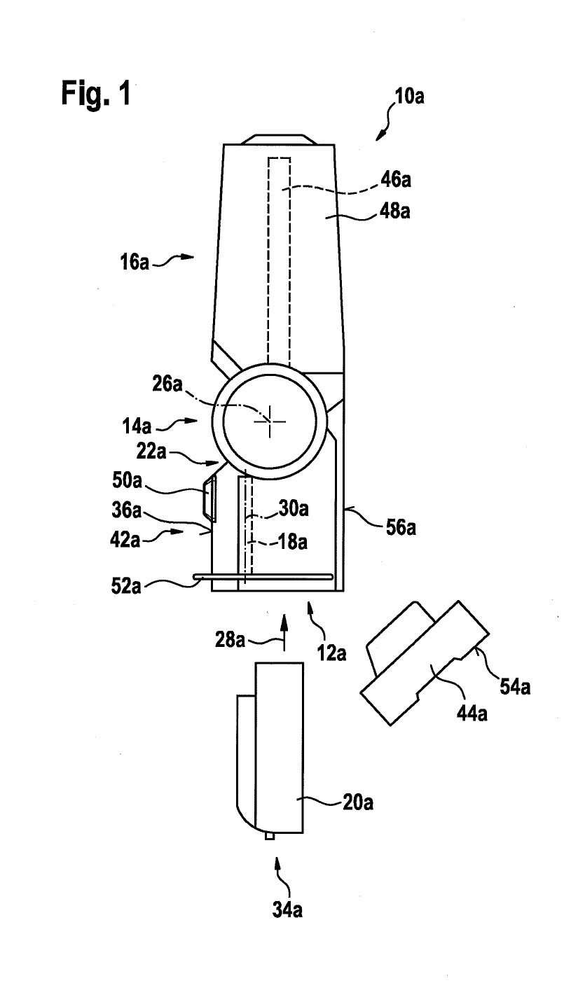

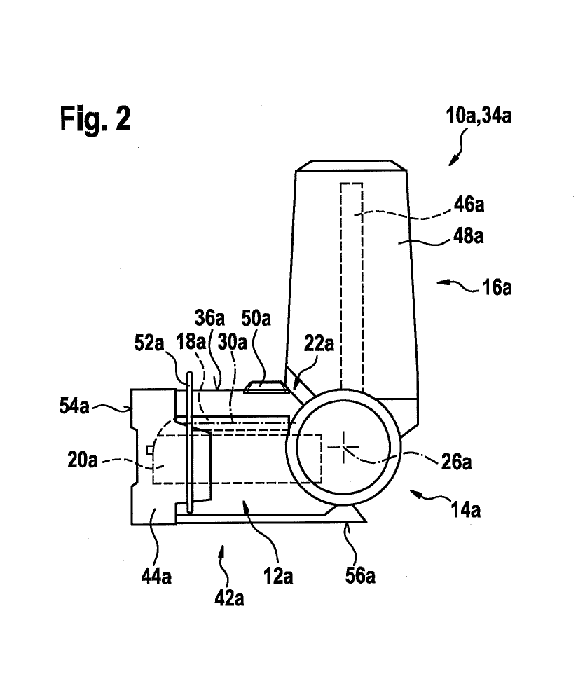

FIGS. 1 and 2 show a system 34a having a hand-lamp device 10a and having a hand-held machine-tool battery 20a. Hand-lamp device 10a includes a battery-receiving area 12a, a swiveling mechanism 14a, a lighting device 16a and a coupling device 18a. Battery-receiving area 12a is located within a hand grip 42a of hand-lamp device 10a. Hand grip 42a has a battery cover 44a which, in a ready-to-operate state, closes an opening of battery-receiving area 12a.

Coupling device 18a has contacts and a detention arrangement, not shown in greater detail, which, in a ready-to-operate state, contact a hand-held machine-tool battery 20a located in battery-receiving area 12a. When the alignment of swiveling mechanism 14a is angled, coupling device 18a is situated between lighting device 16a and battery-receiving area 12a. To achieve contacting, hand-held machine-tool battery 20a is able to be pushed by an operator in a coupling direction 28a into hand grip 42a. Coupling direction 28a is aligned from battery cover 44a in the direction of swiveling mechanism 14a. Coupling device 18a contacts hand-held machine-tool battery 20a, located in battery-receiving area 12, in a manner allowing disengagement without using a tool.

Swiveling mechanism 14a supports lighting device 16a in a manner allowing it to swivel relative to coupling device 18a about a swivel axis 26a, and specifically, by approximately 180 degrees. Swiveling mechanism 14a is disposed in an immediate area 22a of coupling device 18a, and to be more precise, swivel axis 26a is situated approximately 4 cm away from coupling device 18a. A distance between a bearing surface (not further shown) of swiveling mechanism 14a and a contact of coupling device 18a is approximately 2 cm.

Swivel axis 26a is situated in coupling direction 28a of coupling means 18a behind coupling device 18a, and more precisely, between a middle swiveling position of lighting device 16a shown in FIG. 1, and battery-receiving area 12a. It is aligned perpendicularly to coupling direction 28a and parallel to a coupler plane 30a of coupling device 18a.

Lighting device 16a has an illuminant 46a. Illuminant 46a is in the form of a low-pressure gas-discharge lamp, and specifically, a fluorescent tube. Illuminant 46a has a main extension direction perpendicular to swivel axis 26a. The principal beam directions of illuminant 46a are oriented perpendicularly to the main extension direction. Lighting device 16a includes an impact-resistant illuminant housing 48a.

System 34a has a gripping surface 36a. Gripping surface 36a is located completely on hand grip 42a of hand-lamp device 10a. In a ready-to-operate state, hand-held machine-tool battery 20a is integrated completely into hand-lamp device 10a, and therefore is not able to be grasped. However, gripping surface 36a surrounds hand-held machine-tool battery 20a in the manner of a cylinder sleeve. Thus, a volume area of hand-held machine-tool battery 20a is used as hand grip 42a. An operator-control element 50a is located on gripping surface 36a.

Hand-lamp device 10a has a protection device (not shown more precisely). The protection device is effective between battery cover 44a and a remainder of hand-lamp device 10a. Owing to the protection device, hand-lamp device 10a is protected in a manner allowing it to be used in a potentially explosive atmosphere. Among other things, the protection device protects coupling device 18a. In addition, hand-lamp device 10a has electronics (not further shown). The electronics supply lighting device 16a with energy. The electronics have a circuit which monitors a state of charge of the hand-held machine-tool battery and signals it by light signals, and specifically, of lighting device 16a.

Hand-lamp device 10a further includes a mounting bracket 52a. With the aid of mounting bracket 52a, hand-lamp device 10a is able to be secured in suspended fashion and is conveniently portable. In addition, system 34a has two supporting surfaces 54a, 56a which provide stability when setting system 34a down on a surface. Supporting surfaces 54a, 56a are aligned parallel to swivel axis 26a. Supporting surfaces 54a, 56a are aligned perpendicularly to each other. In one operating state, system 34a has on one plane a nearly rectangular exterior form perpendicular to a main extension.

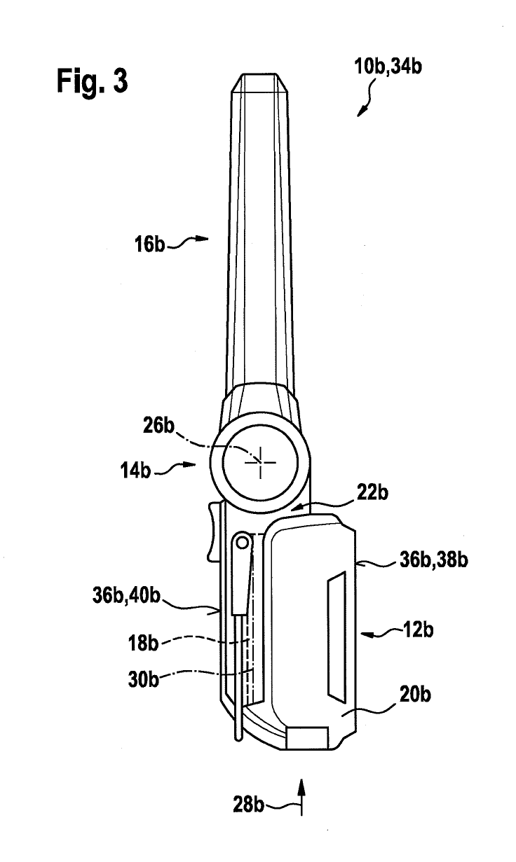

FIGS. 3 through 5 show three further exemplary embodiments of the present invention. The following descriptions and the figures are limited generally to the differences between the exemplary embodiments; with respect to identically labeled components, especially with regard to components having the same reference numerals, in general, reference may also be made to the figures and/or the description of the other exemplary embodiments, especially of FIGS. 1 and 2. To differentiate the exemplary embodiments, the letter a is placed after the reference numerals of the exemplary embodiment in FIGS. 1 and 2. In the exemplary embodiments of FIGS. 3 through 5, the letter a is replaced by the letters b through d.

FIG. 3 shows a system 34b having a hand-lamp device 10b and a hand-held machine-tool battery 20b. Hand-lamp device 10b includes a battery-receiving area 12b, a swiveling mechanism 14b, a lighting device 16b and a coupling device 18b. Swiveling mechanism 14b is disposed in an immediate area 22b of coupling means 18b, and specifically, approximately 3.5 cm away. Swiveling mechanism 14b supports lighting device 16b in a manner allowing it to move by 180 degrees about a swivel axis 26b. Lighting device 16b is shown in a middle swivel position. In one operating state, coupling device 18b is situated between lighting device 16b and battery-receiving area 12b. Battery-receiving area 12b is disposed on the outside of coupling means 18b.

The system has a gripping surface 36b. A part 38b of gripping surface 36b is located on a surface of hand-held machine-tool battery 20b. A part 40b of gripping surface 36b is located on a surface of hand-lamp device 10b. Thus, gripping surface 36b surrounds cells of hand-held machine-tool battery 20b on one plane by 360 degrees. Part 40b of gripping surface 36b located on the surface of hand-lamp device 10b is smaller than part 38b of gripping surface 36b which is located on a surface of hand-held machine-tool battery 20b.

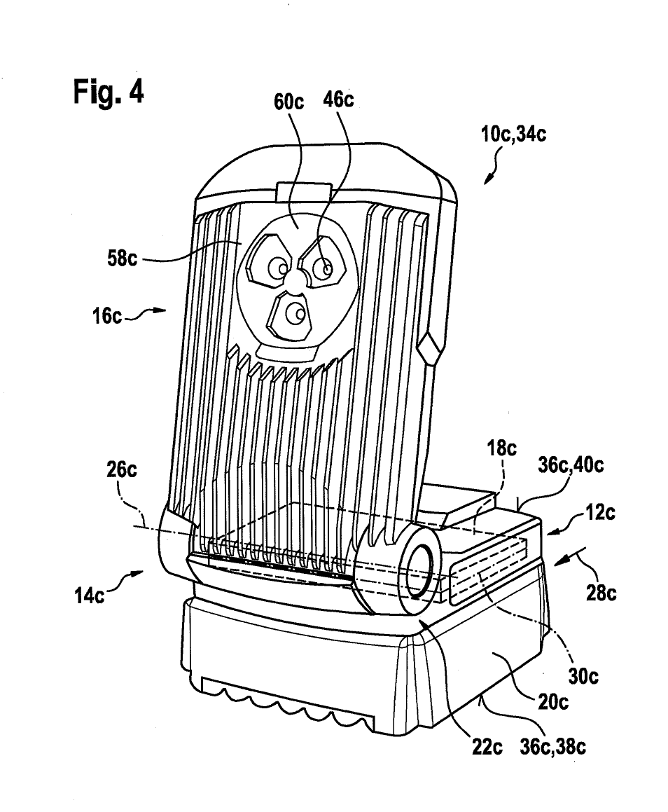

FIG. 4 shows a system 34c having a hand-lamp device 10c and a hand-held machine-tool battery 20c. Hand-lamp device 10c includes a battery-receiving area 12c, a swiveling mechanism 14c, a lighting device 16c and a coupling device 18c. Swiveling mechanism 14c is disposed in an immediate area 22c of coupling means 18c, and specifically, approximately 1 cm away. Swiveling mechanism 14c supports lighting device 16c in a manner allowing it to move by 180 degrees about a swivel axis 26c. In one operating state, coupling means 18c is situated between lighting device 16c and battery-receiving area 12c. A middle swivel position is aligned in a direction perpendicular to a coupling direction 28c of coupling means 18c.

Lighting device 16c has a cooling element 58c and three illuminants 46c in the form of light-emitting diodes. Cooling element 58c has an outer surface which is disposed in the beam direction of illuminants 46c behind an outside surface of the illuminants shown through during operation. Cooling element 58c is provided to cool illuminants 46c. In addition, cooling element 58c cools electronics (not further shown). In addition, lighting device 16c has a movably disposed diffuser 60c. Diffuser 60c is able to swivel into a luminous flux of illuminants 46c.

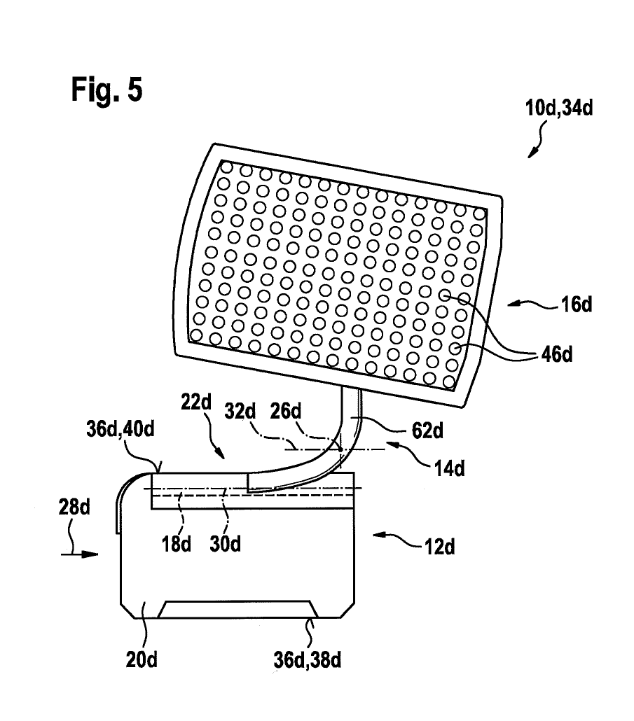

FIG. 5 shows a system 34d having a hand-lamp device 10d and a hand-held machine-tool battery 20d. Hand-lamp device 10d includes a battery-receiving area 12d, a swiveling mechanism 14d, a lighting device 16d and a coupling device 18d. Swiveling mechanism 14d is disposed partially in an immediate area 22d of coupling means 18d, and specifically, approximately 1 cm away. Swiveling mechanism 14d supports lighting device 16d in a manner allowing it to move about at least two swivel axes 26d, 32d marked in by way of example. To that end, swiveling mechanism 14d has what is termed a gooseneck 62d.

Lighting device 16d is latchable with coupling device 18d. In that context, a lighting direction of lighting device 16d points away from coupling means 18d. Lighting device 16d abuts flat against coupling means 18d. Lighting device 16d has an illuminant 46d in the form of a surface illuminant. It includes a plurality of light-emitting diodes.

1-10. (canceled)

11. A hand-lamp device, comprising:
a battery-receiving area;
a swiveling mechanism;
a lighting device; and
a coupling device to contact a hand-held machine-tool battery located in the battery-receiving area, and which, in at least one operating state, is situated between the lighting device and the battery-receiving area, the swiveling mechanism being situated at least partially in an immediate area of the coupling device.

12. The hand-lamp device as recited in claim 11, wherein the swiveling mechanism has at least one swivel axis situated in a coupling direction of the coupling device behind the coupling device.

13. The hand-lamp device as recited in claim 12, wherein the swivel axis of the swiveling mechanism is aligned in a direction perpendicular to a coupling direction of the coupling device.

14. The hand-lamp device as recited in claim 12, wherein a swivel axis of the swiveling mechanism is aligned parallel to a coupler plane of the coupling device.

15. The hand-lamp device as recited in claim 11, wherein the swiveling mechanism provides support to the lighting device in a manner allowing the lighting device to move about at least two swivel axes.

16. The hand-lamp device as recited in claim 11, wherein the coupling device is provided to contact the hand-held machine-tool battery disposed in the battery-receiving area in a manner able to be disengaged without using a tool.

17. A system, comprising:
a hand-held machine-tool battery; and
a hand-lamp device including a battery receiving area, a swiveling mechanism, a lighting device, and a coupling device to contact a hand-held machine-tool battery located in the battery-receiving area, and which, in at least one operating state, is situated between the lighting device and the battery-receiving area, the swiveling mechanism being situated at least partially in an immediate area of the coupling device; and
at least one gripping surface that at least partially surrounds at least one part of the hand-held machine-tool battery.

18. The system as recited in claim 17, wherein at least one part of the gripping surface is located on a surface of the hand-held machine-tool battery.

19. The system as recited in claim 18, wherein at least one part of the gripping surface is located on a surface of the hand-lamp device which is smaller than a part of the gripping surface which is located on the surface of the hand-held machine-tool battery.

20. The system as recited in claim 17, further comprising:
a protection device to protect the coupling device.
